(19) United States
(12) Patent Application Publication
(10) Pub. No.: US 2009/0045314 A1
(43) Pub. Date: Feb. 19, 2009

(54) Wall mount clip for sheet like material such as paper/pictures

(76) Inventor: Chin-Hsiung Lien, El Monte, CA (US)

Correspondence Address: DAVID AND RAYMOND PATENT FIRM, 108 N. YNEZ AVE., SUITE 128, MONTEREY PARK, CA, 91754, US

(21) Appl. No.: 11/893,755

(22) Filed: Aug. 17, 2007

(51) Int. Cl. B65D 85/00; A47B 96/06; G09F 3/16; A47B 97/00; A47B 97/04

(52) U.S. Cl. 248/452; 248/451; 206/449; 248/205.1; 40/658

(57) ABSTRACT

A wall mount clip for sheet like materials includes a sheet base and a sheet retainer, wherein the upper end of the sheet retainer is mounted together with the upper end of the sheet base, and the sheet retainer is extended downwardly to the curled lower end which provides resilient force due to deformation of the sheet retainer. The contact point between the curled lower end and the sheet base extends continuously and latitudinally along the elongated lower end to form a contact line to exert said resilient force to hold the sheet like materials. The user can easily slide the sheet materials from the contact point from various angles upwardly to the empty space created by the sheet base and sheet retainer. The wall mount clip will not damage the sheet materials because the resilient is smaller than that generated by conventional clips.

### BACKGROUND OF THE PRESENT INVENTION

1. Field of Invention

This invention is to provide a wall mount slip, and more particularly to a wall mount clip wherein the sheet like material can be easily slid into the cavity of the clip by the inserting force of the sheet without causing damage on the material itself.

2. Description of Related Arts

Clips have been widely utilized for holding sheet like materials. A conventional clip is a strip of stainless sheet steel bent into the shape of an isosceles triangle with loops at the top thereof. Tension along the base of the triangle forces the two sides closed and the loops prevent the sharp steel edges from cutting into the paper. The loops also serve to hold two pieces of stiff wire, which serve as handles and allow the clip to be opened to hold sheet like materials. In other words, the conventional clip remains closed when not in use and external force has to be applied to open the clip to hold sheet like materials.

However, the conventional clip suffers from its own limitations. First, the user has to apply certain amount of external force to open the clip and if one of the handles is missing, it is unlikely for the user to open the clip with bare hands. Furthermore, the tension along the base of the triangle is usually huge enough to cause damage on the surfaces of sheet materials. Damage usually occurs when the material is held for a long period of time or the material is vulnerable itself, such as a film.

When the sheet material is wider, a series of clips has to be used to hold the material. The more the clips are used, the more damages may occur on the surface of the material as discussed above. In addition, this clip arrangement impairs the aesthetic value as a whole.

When the conventional clip is used to hold sheet materials on the wall, it is difficult for the user to fasten the clip on the wall by hanging the clip on an existing pin thereon. Also, it is inconvenient for the user to apply force to the handles to open the hung clip. Finally, the clip constitutes a protruding part on the wall and injuries to people may result when inadvertent contact occurs.

### SUMMARY OF THE PRESENT INVENTION

A main object of the present invention is to provide a wall mount clip for sheet materials which can be slid into the clip by the inserting force of the sheet to avoid damages on the surfaces of the materials, wherein a lower edge portion is formed to hold the sheet material.

Another object of the present invention is to provide a wall mount clip for sheet materials, comprising a sheet base and a sheet retainer wherein the sheet base is mounted on the wall and the upper portions of the sheet base and the sheet retainer are mounted together with each other, wherein the upper clamping portion is formed to hold and align the sheet material in addition to the lower edge portion.

Another object of the present invention is to provide a wall mount clip for sheet materials, wherein the sheet base is at least of the same length as the sheet retainer which has a spiral lower edge portion generating resilient force to hold the sheet material placed between the sheet base and the spiral lower edge portion.

Another object of the present invention is to provide a wall mount clip for sheet materials, wherein the manufacturing process of the wall mount clip is less complicated and less expensive than conventional clips.

Another object of the present invention is to provide a wall mount clip for sheet materials, wherein the clip can be stably fastened on the wall with no protruding portion thereon, and is convenient for the user to detach the clip and re-mounts it based on the user's needs.

These and other objectives, features, and advantages of the present invention will become apparent from the following detailed description, the accompanying drawings, and the appended claims.

### BRIEF DESCRIPTION OF THE DRAWINGS

FIG. 1 is a schematic view of a wall mount clip according to a preferred embodiment of the present invention.

FIG. 2 is a sectional view of the wall mount clip according to the above preferred embodiment of the present invention.

FIG. 3 illustrates an alternative mode of the fastening element of the wall mount clip according to the above preferred embodiment of the present invention.

FIG. 4 illustrates an alternative mode of the wall mount clip according to the above preferred embodiment of the present invention, illustrating the sheet base with multiple sheet retainers of the present invention.

FIG. 5 illustrates a first alternative mode of the sheet retainer of the wall mount clip according to the above preferred embodiment of the present invention.

FIG. 6 illustrates a second alternative mode of the sheet retainer of the wall mount clip according to the above preferred embodiment of the present invention.

### DETAILED DESCRIPTION OF THE PREFERRED EMBODIMENT

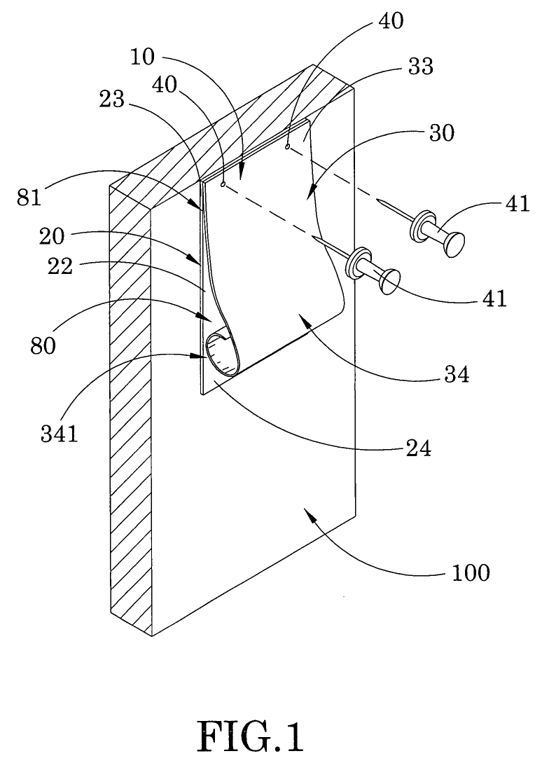

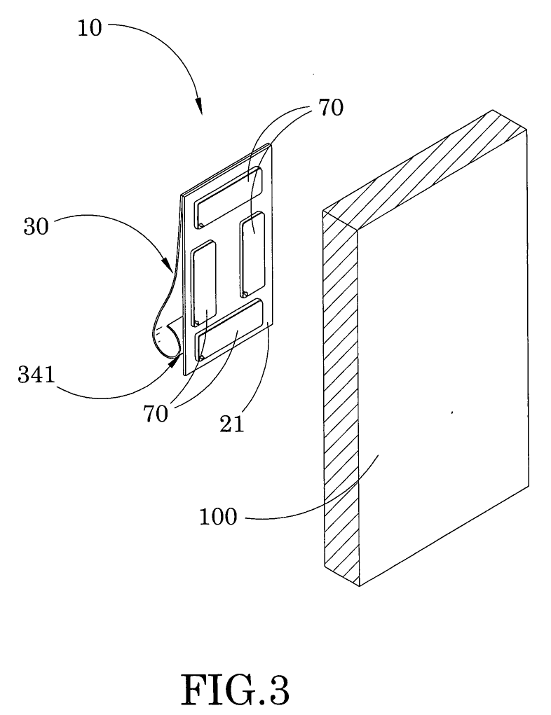

Referring to FIG. 1 and FIG. 3, a wall mount clip 10 according to a preferred embodiment of the present invention is illustrated, wherein the wall mount clip 10, which is adapted for affixing on a wall surface 100 to hold a sheet-like material on the wall, comprises a sheet-like sheet base 20 and a sheet-like sheet retainer 30.

According to the preferred embodiment, the sheet base 20, which is adapted for being affixed on the wall surface 100, has a rear side 21 biased against the wall surface 100, a front side 22, an upper portion 23 and a lower portion 24.

The sheet retainer 30 is made of resilient material, having a lower edge portion 34 with a longitudinal holding edge 341 and an upper portion 33 overlapped with the upper portion 23 of the sheet base 20 to provide a resilient force along the holding edge 341 to substantially bias against the front side 22 of the sheet base 20. At least one mounting slot 40 is provided at the upper portions 23 and 33 of the sheet base 20 and the sheet retainer 30 respectively to affix the sheet base 20 on the wall surface 100 via at least one pin 41 inserted into the wall surface 100 through the mounting slot 40, wherein the mounting slot 40 of the upper portion 33 of the sheet retainer 30 is aligned with that of the upper portion 23 of the sheet base 20 to ensure the upper portion 33 of the sheet retainer 30 is overlapped and mounted to the upper portion 23 of the sheet base 20 and the pin 41 is inserted through both upper portions 23 and 3333 of the sheet base 20 and the sheet retainer 30, and affix the clip on the wall surface 100.

Accordingly, when the upper portion 23 of the sheet base 20 is overlapped with the upper portion 33 of the sheet retainer 30, a sheet cavity 80 is formed between the sheet base 20 and the sheet retainer 30. The sheet cavity 80 has a width increasing from the upper portion 33 of the sheet retainer 30 towards the holding edge 341, wherein when the holding edge 341 is spacedly moved apart from the front side 22 of the sheet base 20, a longitudinal opening is formed between the holding edge 341 and the front side 22 of the sheet base 20. It is worth to mention that the longitudinal opening is formed by an inserting force of a sheet 200, such that when an edge portion of the sheet 200 is slid into the sheet cavity 80, the sheet 200 is retained on the wall surface 100. In other words, the inserting force of the sheet 200 will move the holding edge 341 spacedly apart from the front side 22 of the sheet base 20 to slide the edge portion of the sheet 200 into the sheet cavity 80.

In a preferred embodiment, the sheet retainer 30 is made by metal with inherent resilient force when the metal sheet is bent. The lower edge portion 34 of the sheet retainer 30 is bent in a spiral shape to form the holding edge 341 so that the holding edge 341 is tangently biased against the front side 22 of the sheet base 20 to provide an additional resilient force along the holding edge 341 of the sheet retainer 30 via the spiral shaped of the lower edge portion 34 of the sheet retainer 30.

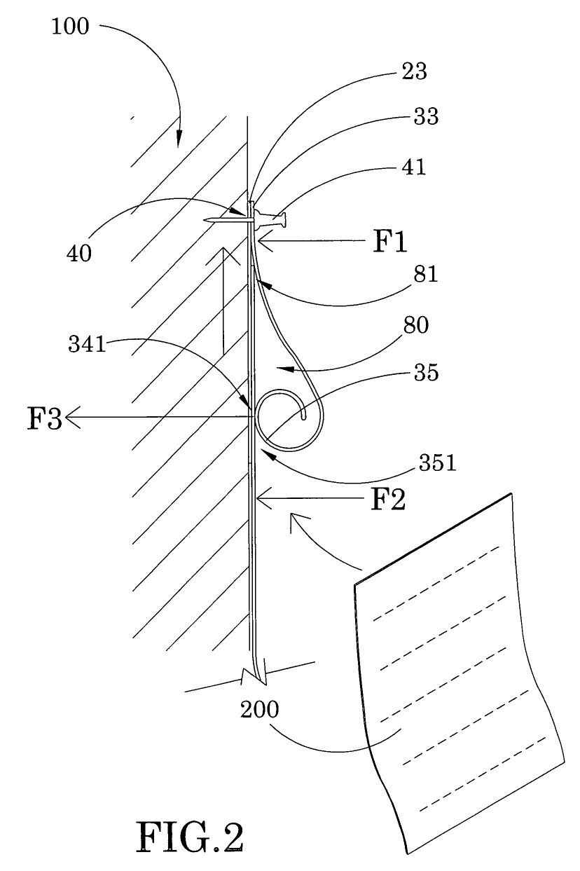

As can be seen in FIG. 2, the sheet retainer 30 has a guiding edge portion 35 downwardly extended from the holding edge 341 to define a guiding area 351 between the guiding edge portion 35 and the front side 22 of the sheet base. The guiding area 351 has a width reducing towards the holding edge 341 for guiding the edge portion of the sheet 200 being inserted into the sheet cavity 80 through the longitudinal opening. In other words, the edge portion of the sheet 200 is guided to slide towards the longitudinal opening through the guiding area 351 such that the user is able to easily insert the edge portion of the sheet 200 into the sheet cavity 80 without any precise alignment.

It is worth mentioning that the holding edge 341 of the sheet retainer 30 is biased against the front side 22 of the sheet base at a position above the lower portion 24 thereof, such that the sheet 200 can be inserted along with the front side 22 of the sheet base 20 to the longitudinal opening, then to the sheet cavity 80 between the sheet base 20 and the sheet retainer 30.

More specifically, a contact point is formed where the holding edge 341 tangently contacts the front side 22. In a preferred embodiment, the lower edge portion 34 is formed in a spiral shape and the contact point is extended continuously and longitudinally along the elongated lower edge portion 34 to form a contact line. Thus, the additional resilient force can be applied to the sheet material through the contact line when the sheet 200 is inserted along with the front side 22 of the sheet base 20 to the longitudinal opening.

As shown in FIG. 2, the guiding edge portion 35 of the sheet retainer 30 has a curved shape downwardly extended from the holding edge 341 and curved out with respect to the front side 22 of the sheet base 20 to define the guiding area 351 therebetween. More specifically, the guiding edge portion 35 of the sheet retainer 30 is inclinedly and downwardly extended from the holding edge 341 and inclinedly extended out with respect to the front side 21 of the sheet base 20 to define the guiding area 351. The user can easily insert the sheet 200 from the guiding area 351 to the holding edge 341, overcome the resilient force and slide the sheet 200 all the way to the upper portion of the sheet cavity 80 of the clip. It is worth mentioning that the upper portions 23 and 33 of the sheet base 20 and the sheet retainer 30 respectively are overlapped as illustrated above and each upper portion has at least one mounting slot 40 of the mounted together by at least a pin 41 to provide an upper clamping portion 81 between the sheet base 20 and the sheet retainer 30 to hold and align the edge portion of the sheet 200.

A static analysis of the present invention is illustrated in FIG. 2. When the clip is affixed on the wall through a pin 41 at the upper portions 23 and 33 of the sheet base 20 and the sheet retainer 30 respectively, a force F₁ is exerted back to the upper portions 23 and 33 of the sheet base 20 and the sheet retainer 30. Likewise, a force F₂ is exerted back to the lower portion 24 of the sheet base 20. In order to be held balancedly on the wall surface 100, a force F₃ is exerted from the lower portion 34 to the wall surface 100 and the magnitude is equal to the summation of F₁ and F₂. In other words, when the sheet 200 is inserted into the clip, the force which the user has to overcome is equal to that exerted from the lower portion 34 to the wall surface 100 (F₃), which is equal to the summation of the forces exerted to the upper and lower portion of the clip (F₁+F₂).

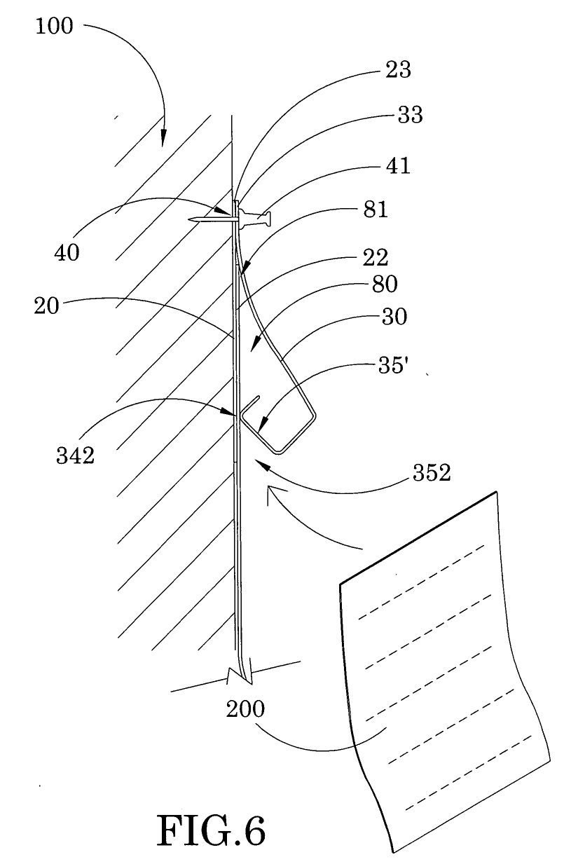

Alternatively, the lower edge portion 34 of the sheet retainer 30 can be bent in a diamond shape as shown in FIG. 6. Likewise, the holding edge 342 is tangently biased against the front side 22 of the sheet base 20 to provide an additional resilient force along the holding edge 342 of the sheet retainer 30 via the diamond shaped lower edge portion 34 of the sheet retainer 30. The contact point and contact line illustrated above are also formed with the diamond shape holding edge 341. Furthermore, a guiding portion 35′ of the sheet retainer 30 is inclinedly and downwardly extended from the holding edge 342 and inclinedly extended out with respect to the front side 22 of the sheet base 20 to define the guiding area 352 therebetween. Likewise, the user can insert the sheet from the guiding area 352, upwardly slide the sheet to overcome the resilient force, and move the sheet all the way up to the upper clamping portion 81 as defined above.

The wall mount clip 10 is detachably affixed to the wall by at least one pin 41, such that it is convenient for the user to place the clip according to the user's needs. Furthermore, the protruding portion of the pins 41 can be slightly decorated to increase the aesthetic value of the clip. Alternatively, the wall mount clip 10 can be mounted on the wall by double-sided adhesives 70 as an alternative fastening element, as shown in FIG. 3. More specifically, the double-sided adhesive is placed on the rear side 21 of the sheet base 20. The double-sided adhesive 70 can also be used between the upper portions 23 and 33 of the sheet base 20 and sheet retainer 30 respectively. Thus, the clip can be affixed on the wall surface 100 without using any pin, as shown in FIG. 3.

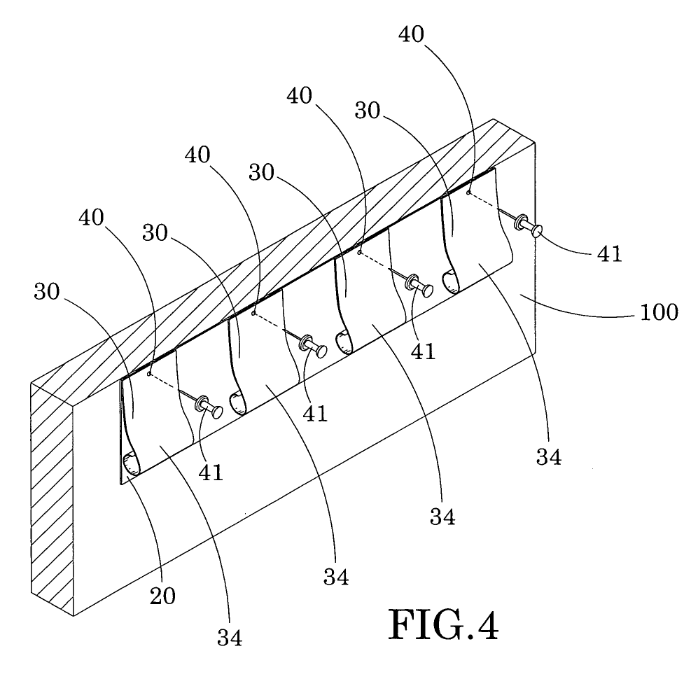

As can be seen in FIG. 4, a plurality of clips in the present invention can be placed spacedly and parallelly for a wide sheet material. More specifically, a plurality of sheet retainers 30 shares the same sheet base 20. This clip arrangement can also be used in restaurants in which the menus or orders can be properly held by the clips. Similarly, in the exhibition room, a series of pictures or photos can be displayed by using this clip arrangement.

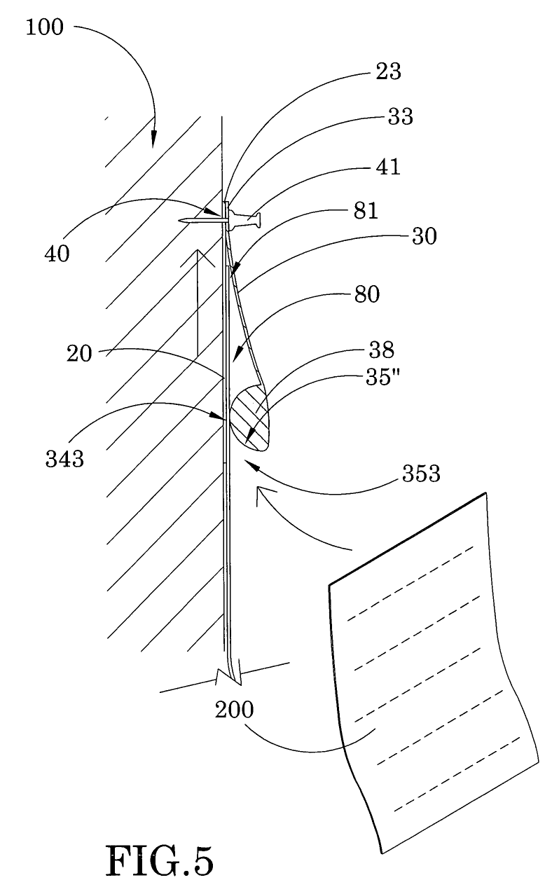

The lower edge portion 34 of the sheet retainer 30 is not necessary to be spiral as can be seen in FIG. 5. Alternatively, an elongated clipping member 38 with a curved edge, longitudinally protrudes along the lower edge portion 34 of the sheet retainer 30 to define the holding edge 343 at the curved edge of the clipping member 38 and to tangently bias against the front side 22 of the sheet base 20. The sheet retainer 30 is then deformed by placing the clipping member 38 biased against the front side 22 of the sheet base 20, and the resilient force is thus generated to hold the sheet material 200.

Likewise, the clipping member 38 has a guiding edge portion 35″ downwardly extended from the holding edge 343 to define a guiding area 353 between the guiding edge portion 35″ and the front side 22 of the sheet base. The guiding area 353 has a width reducing towards the holding edge 343 for guiding the edge portion of the sheet 200 being inserted into the sheet cavity 80 through the longitudinal opening. It is worth mentioning that the holding edge 343 of the sheet retainer 30 is biased against the front side 22 of the sheet base 20 at a position above the lower portion 24 thereof, such that the sheet 200 can be inserted along with the front side 22 of the sheet base 20 to the longitudinal opening, then to the sheet cavity 80 between the sheet base 20 and the sheet retainer 30. The user can insert the sheet 200 from the guiding area 353, upwardly slide the sheet 200 to overcome the resilient force, and move the sheet 200 all the way up to the upper clamping portion 81 as defined above.

Comparing to conventional clips, one of the major advantages of the clip in the present invention is that the user can easily slide the sheet materials upwardly to overcome the resilient force from the lower portion, and the same amount of force is not even enough to open the conventional clip. The clip of the present invention does not require any external force applied to the clip to open the opening and then to slide the sheet 200 into the sheet cavity 80. By simply applying the inserting force of the sheet 200, the holding edge 341 can be pushed to move spacedly apart from the front side 22 of the sheet base 20 so as to open up the sheet cavity 80. In other words, one simple action of sliding the sheet 200 towards the guiding area 251 can clip the sheet 200 on the wall surface 100 via the clip of the present invention. Furthermore, the force exerted on the sheet material from the lower edge portion 34 is moderate, such that the sheet material is less likely to be damaged even being held by the clip for a long period of time. Comprising with two pieces of metal and at least one pin, the manufacturing process of the present invention is much easier than conventional clips, and the manufacturing cost is thus reduced.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A wall mount clip for holding a sheet on a wall surface, comprising:
a sheet-like sheet base, which is adapted for being affixed on said wall surface, having a rear side adapted for biasing against said wall surface, a front side, an upper portion, and a lower portion; and
a sheet-like sheet retainer, which is made of resilient material, having a lower edge portion having a longitudinal holding edge and an upper portion overlapped with said upper portion of said sheet base to provide a resilient force along said holding edge to substantially bias against said front side of said sheet base, wherein a sheet cavity, which is formed between said sheet base and said sheet retainer, has a width increasing from said upper portion of said sheet retainer towards said holding edge, wherein said holding edge of said sheet retainer is arranged to spacedly move apart from said front side of said sheet base to form a longitudinal opening by an inserting force of said sheet, such that when an edge portion of said sheet is slid into said sheet cavity, said sheet is retained on said wall surface.

2. The wall mount clip, as recited in claim 1, wherein said sheet retainer further has a guiding edge portion downwardly extended from said holding edge to define a guiding area between said guiding edge portion and said front side of said sheet base, wherein said guiding area has a width reducing towards said holding edge for guiding said edge portion of said sheet being inserted into said sheet cavity through said longitudinal opening.

3. The wall mount clip, as recited in claim 1, wherein said holding edge of said sheet retainer is biased against said front side of said sheet base at a position above said lower portion thereof.

4. The wall mount clip, as recited in claim 2, wherein said holding edge of said sheet retainer is biased against said front side of said sheet base at a position above said lower portion thereof.

5. The wall mount clip, as recited in claim 2, wherein said lower edge portion of said sheet retainer is bent in a spiral shape that said holding edge is tangently biased against said front side of said sheet base to provide an additional resilient force along said holding edge of said sheet retainer.

6. The wall mount clip, as recited in claim 4, wherein said lower edge portion of said sheet retainer is bent in a spiral shape that said holding edge is tangently biased against said front side of said sheet base to provide an additional resilient force along said holding edge of said sheet retainer.

7. The wall mount clip, as recited in claim 5, wherein said guiding edge portion of said sheet retainer has a curved shape downwardly extended from said holding edge and curved out with respect to said front side of said sheet base to define said guiding area therebetween.

8. The wall mount clip, as recited in claim 6, wherein said guiding edge portion of said sheet retainer has a curved shape downwardly extended from said holding edge and curved out with respect to said front side of said sheet base to define said guiding area therebetween.

9. The wall mount clip, as recited in claim 2, said lower edge portion of said sheet retainer is bent in a diamond shape that said holding edge is tangently biased against said front side of said sheet base to provide an additional resilient force along said holding edge of said sheet retainer.

10. The wall mount clip, as recited in claim 4, said lower edge portion of said sheet retainer is bent in a diamond shape that said holding edge is tangently biased against said front side of said sheet base to provide an additional resilient force along said holding edge of said sheet retainer.

11. The wall mount clip, as recited in claim 9, wherein said guiding edge portion of said sheet retainer is inclinedly and downwardly extended from said holding edge and inclinedly extended out with respect to said front side of said sheet base to define said guiding area therebetween.

12. The wall mount clip, as recited in claim 10, wherein said guiding edge portion of said sheet retainer is inclinedly and downwardly extended from said holding edge and inclinedly extended out with respect to said front side of said sheet base to define said guiding area therebetween.

13. The wall mount clip, as recited in claim 2, wherein said sheet retainer comprises an elongated clipping member, having a curved edge, longitudinally protruding along said lower edge portion of said sheet retainer to define said holding edge at said curved edge of said clipping member and to tangently bias against said front side of said sheet base.

14. The wall mount clip, as recited in claim 4, wherein said sheet retainer comprises an elongated clipping member, having a curved edge, longitudinally protruding along said lower edge portion of said sheet retainer to define said holding edge at said curved edge of said clipping member and to tangently bias against said front side of said sheet base.

15. The wall mount clip, as recited in claim 13, wherein said guiding edge portion of said sheet retainer has a curved shape downwardly extended from said holding edge and curved out with respect to said front side of said sheet base to define said guiding area therebetween.

16. The wall mount clip, as recited in claim 14, wherein said guiding edge portion of said sheet retainer has a curved shape downwardly extended from said holding edge and curved out with respect to said front side of said sheet base to define said guiding area therebetween.

17. The wall mount clip, as recited in claim 1, further containing two mounting slots provided at said upper portions of said sheet base and said sheet retainer respectively, wherein said sheet base is adapted for affixing on said wall surface via a pin inserting into said wall surface through said mounting slots to ensure said upper portion of said sheet retainer being overlapped on said upper portion of said sheet base so as to further hold said edge portion of said sheet between said upper portions of said sheet base and said sheet retainer.

18. The wall mount clip, as recited in claim 8, further containing two mounting slots provided at said upper portions of said sheet base and said sheet retainer respectively, wherein said sheet base is adapted for affixing on said wall surface via a pin inserting into said wall surface through said mounting slots to ensure said upper portion of said sheet retainer being overlapped on said upper portion of said sheet base so as to further hold said edge portion of said sheet between said upper portions of said sheet base and said sheet retainer.

19. The wall mount clip, as recited in claim 12, further containing two mounting slots provided at said upper portions of said sheet base and said sheet retainer respectively, wherein said sheet base is adapted for affixing on said wall surface via a pin inserting into said wall surface through said mounting slots to ensure said upper portion of said sheet retainer being overlapped on said upper portion of said sheet base so as to further hold said edge portion of said sheet between said upper portions of said sheet base and said sheet retainer.

20. The wall mount clip, as recited in claim 16, further containing two mounting slots provided at said upper portions of said sheet base and said sheet retainer respectively, wherein said sheet base is adapted for affixing on said wall surface via a pin inserting into said wall surface through said mounting slots to ensure said upper portion of said sheet retainer being overlapped on said upper portion of said sheet base so as to further hold said edge portion of said sheet between said upper portions of said sheet base and said sheet retainer.
